(19) United States
(12) Patent Application Publication
(10) Pub. No.: US 2007/0171158 A1
(43) Pub. Date: Jul. 26, 2007

(54) LOW POWER LED-BASED MARQUEE SYSTEMS

(76) Inventor: Shalabh Kumar, Kildeer, IL (US)

Correspondence Address: AUTOTECH TECHNOLOGIES, LLP, 4140 UTICA RIDGE ROAD, BETTENDORF, IA, 52722, US

(21) Appl. No.: 11/625,816

(22) Filed: Jan. 22, 2007

Related U.S. Application Data
(60) Provisional application No. 60/766,481, filed on Jan. 22, 2006.

(51) Int. Cl. G09G 3/32

(52) U.S. Cl. 345/82

(57) ABSTRACT

A low power LED based marquee is described. The LEDs are powered by 3.3 VDC.

### CROSS REFERENCE TO RELATED APPLICATIONS

This application is entitled to the benefit of Provisional Patent Application Ser. No. 60/766,481 submitted on Jan. 22, 2006.

### FEDERALLY SPONSORED RESEARCH

Not applicable.

### SEQUENCE LISTING OR PROGRAM

Not applicable

### FIELD OF INVENTION

The invention pertains to the field of LED based marquee displays.

### BACKGROUND OF INVENTION

LED based marquees are increasingly being used to display information everywhere. The marquees can be seen in manufacturing plants displaying productivity and alarm information, in retail shops displaying sales items, in trains and buses displaying destinations, in airports displaying departure and arrival information. The marquee signs are large in size and may have 1000's of LEDs depending up on number of characters. These LEDs may be driven by 12 VDC. Since the LED voltage drop is only about 2 VDC, the rest of the voltage is dropped across switching elements, and current limiting resistors. This creates a lot of wastage of power, require bulky power supplies, heat sinks etc. In addition based on the number of LEDs on simultaneously, there are voltage swings requiring either a regulated voltage or constant current source.

Current invention describes a design that reduces power requirements by operating marquee at a lower voltage and using switching elements with low resistance.

### BRIEF DESCRIPTION OF DRAWINGS

FIG. 1 shows a block diagram of a low power marquee. The diagram highlights the technique of driving marquee LEDs.

FIG. 2 shows schematic of driving a typical single LED.

### DESCRIPTION OF INVENTION

LED marquee consists of a number of LED blocks, with each block containing a matrix of LEDs. Commonly available blocks have 5×7, 5×8 or 8×8 matrix of LEDs. These blocks are arranged in rows and columns to make a marquee to display a number of characters or graphics in multiple rows. Electronic circuits control the turning on and off individual LEDs to display desired message (including characters including international fonts and graphics) on the marquee.

This invention describes a method that reduces power consumption while maintaining uniform brightness on the LEDs by providing nominally same amount of current to each LED.

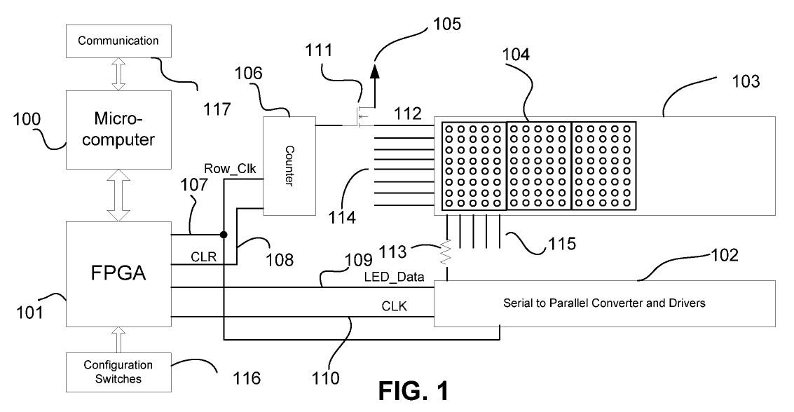

FIG. 1 shows a block diagram of the invention. Block diagram highlights major components of the marquee related to the invention. Microcomputer 100 represents microprocessor and all required peripherals, such as RAM, FLASH, etc for the microprocessor. The FPGA (Field Programmable Gate Array) 101 is programmed by the microcomputer 100 on power up by downloading code to FPGA from a nonvolatile memory such as FLASH. The FPGA 101 is configured to have dual port RAM along with other logic. The dual port RAM is shared by the microcomputer 100 and FPGA 101.

Several LED blocks 104 make up an LED stick 103. The example here shows 5×8 blocks; however the technique may be used with any size of block. The stick is arranged so that anodes of all the LEDs in a row are connected together. There are 8 rows in the example shown, and thus there are 8 connections to anodes, one for each row. Line 112 indicates connection to the anodes of row one, while 114 collectively indicates 7 connections to anodes of rows 2 through 8. The cathodes of each LED in a column of a block are all connected together. Thus there are 5 cathode connections for each LED block.

Each Row (anodes of the all LEDs in the row) is connected to a positive supply 105 through a low R_{DSON} FET 111. In this example the power 105 used is 3.3 VDC. Using this low supply voltage helps reduce the power wasted in current limiting resistor. The figure shows connection only to row one 112. Connections to rows 2-8 114 are identical to the connection for row one, but are omitted from the figure for clarity. The FET 111 acts as a switch, and is controlled by a counter/decoder 106 block. The counter 106 has 8 outputs in this example, with only one output active at a time. The active output turns the connected FET on, turning power on to all the anodes of the LEDs of corresponding row. Logic in FPGA controls this counter.

All cathodes in a column of an LED block are connected together (8 Cathodes in this case). Each such common cathode connection is connected to the output driver of a Serial to parallel converter shift register block 102 through a current limiting resistor 113. Again for clarity the connections for all other column except first one are omitted from the image; they are identical to the one shown in this example. The shift register 102 has one output for each column of the LED stick 103.

To turn on an LED, its row should be selected (anode connected to power through FET), and its column must be selected by the corresponding output (output low) of shift register 103, enabling current flow through the LED. LEDs from one whole row are turned on at the same time time.

Message to be displayed is communicated to the microcomputer 101 through appropriate communication interface 117 and protocol. The communication can be through serial, DeviceNet, Profibus, Ethernet or any other communication network. The message sent to the microcomputer includes displayable characters as well as command codes. Command codes contain message formatting information, such as character size, character color, starting position, etc. The microcomputer decodes command codes, and writes display patterns to the dual port memory in the FPGA 101.

FPGA 101 logic implements a simple state machine. FPGA state machine generates 4 signals, namely Row_Clk 107, CLR 108. LED_Data 109 and CLK 110. CLR 108 synchronizes all signals, and marks beginning of a cycle. The FPGA generated 8 Row_Clk 107 signals between CLR 108 signals. Each Row_Clk 107 signal increments counter/decoder block 106. Counter/decoder makes one of the 8 outputs active, turning on the FET connected to that output, and thereby turning power on to the row corrected to that FET, and turning power off to all other rows.

Between two row clocks, the FPGA reads the display pattern of the next row to be displayed and transfers this data to the serial to parallel shift register 102 using signals LED_Data 109, and CLK 110. The CLK must be fast enough to shift data for all the LED columns before the next Row_Clk signal comes up. The Row_Clk 107 signal is used to transfer shifted data to the outputs of shift register 102. The state machine in the FPGA performs this loop indefinitely.

Thus each LED that should be on is turned-on periodically for a brief period of time. Human eyes perceive LED to be on continuously due to persistence of vision. The frequency of repetition of powering up LEDs should be fast enough for this persistence. In the example shown here, the Row_Clk signal repeats every 2.2 ms, and the each row is re-displayed in 17.8 ms for 2.2 ms.

The example here shows only one line of characters. However the same scheme works for multi-line marquees.

The figure also shows configuration switches 116. In this example configuration switches 116 are used to set marquee size. The switches indicate marquee size in terms of number of rows and number of character per row. This information is used by microprocessor 100 and FPGA 101 to determine size of display pattern memory in dual port RAM in the FPGA, and the amount of data to be transferred to the shift registers.

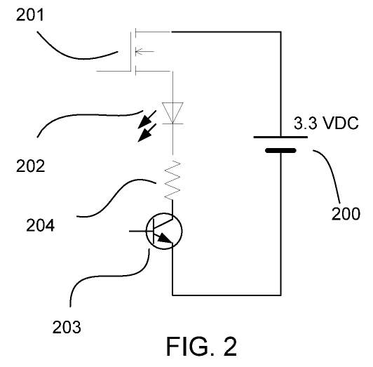

FIG. 2 shows essentially the schematic to turn on a typical LED in the LED matrix. The marquees presented in this invention operate at 3.3 VDC (200) reducing power dissipation in current limiting resistor 204. A very low RDS FET 201 is used, again reducing voltage drop in the switch. Please note the FET 201 supplies current to all the LEDs in one row, unlike BJT 203 which has to sink current only from one LED in a column.

Dual port RAM in the FPGA 101 has two buffers for display patterns. While FPGA 101 transmits display pattern to the shift register, the microcomputer can prepare another display pattern in second buffer. The FPGA switches the new buffer and displays the contents of the new buffer. Because of this, the marquee can provide many effects, such as blinking, scrolling, various character sizes, etc.

What is claimed is:

1. An LED based message display comprising of a matrix of light emitting diodes organized in multiple rows and columns with switching means to switch power on or off to each row or column, said switching means containing field effect transistors with very low on-state resistance.

2. Message display of claim 1 wherein said switching means comprise of said field effect transistors and current limiting resistors.

3. An LED based message display of claim 1 wherein switching means include a high density field programmable gate array controlled by a microprocessor contained in the switching means.

4. Message display of claim 1 wherein said light emitting diodes have pre-sorted uniform luminous intensity.

5. Message display of claim 1 having means to select variety of international fonts for display.

6. Message display of claim 1 having means to communicate to external devices to receive messages to be displayed.

7. Message display of claim 6 wherein said communication means comprise of means to communicate over Ethernet.

8. Message display of claim 6 wherein said communication means comprise of means to communicate over Devicenet or profibus.

9. Message display of claim 6 having means to select the address of said display within a network of such displays.

10. Message display of claim 6 having means to share messages from said external devices with other message displays on a network.

11. An LED based message display comprising of a matrix of light emitting diodes organized in multiple rows and columns with switching means to switch power on or off to each row or column, said power to be a low voltage regulated power supply.

12. An LED based message display comprising of a matrix of light emitting diodes organized in multiple rows and columns with switching means to switch power on or off to each row or column, said power means and switching means having low power losses to eliminate need for an internal fan to dissipate heat from said power losses.
